(19) United States
(12) Patent Application Publication
(10) Pub. No.: US 2019/0187719 A1
(43) Pub. Date: Jun. 20, 2019

(54) EMERGENCY LANE CHANGE ASSISTANCE SYSTEM

(71) Applicant: TRW Automotive U.S. LLC, Livonia, MI (US)

(72) Inventors: Hassan M. El-Khatib, Farmington Hills, MI (US); Gregory O. Lynch, Southfield, MI (US)

(21) Appl. No.: 15/846,271

(22) Filed: Dec. 19, 2017

(51) Int. Cl. G05D 1/02; G05D 1/00; G08G 1/0965; B60Q 1/34; B60W 30/18

(52) U.S. Cl. CPC G05D 1/0246; G05D 1/0088; B60W 2550/20; B60Q 1/346; B60W 30/18163; G08G 1/0965

(57) ABSTRACT

A method of autonomously assisting the operation of a host vehicle traveling on a first lane of a roadway includes detecting the presence of an emergency vehicle along the roadway. The distance between the host vehicle and one of the emergency vehicle and an associated stationary vehicle is monitored. A steering gear is actuated to laterally move the host vehicle out of the first lane when the distance between the host vehicle and one of the emergency vehicle and the stationary vehicle reaches a predetermined value.

### TECHNICAL FIELD

The present invention relates generally to vehicle systems and, more specifically, relates to a system for helping the host vehicle to respond to the presence of an emergency vehicle.

### BACKGROUND

Current driver assistance systems (ADAS—advanced driver assistance system) offer a series of monitoring functions in vehicles. In particular, the ADAS can monitor the environment around the vehicle and notify the driver of the vehicle of conditions therein. To this end, the ADAS can capture images of the surrounding environment and digitally process the images to extract information. The later information is used to warn the driver of road obstacles located along the driving path. Common ADAS systems include automatic emergency braking (AEB) to help prevent rear-end collision and adaptive cruise control (ACC) to help mitigate pre-set vehicle speed to keep a safe distance from a following vehicle. ADAS systems can also include lane detection (LD) to help maintain the vehicle within the intended driving lane.

### SUMMARY

In one aspect of the present invention, a method of autonomously assisting the operation of a host vehicle traveling on a first lane of a roadway includes detecting the presence of an emergency vehicle along the roadway by identifying the warning light patterns. The distance between the host vehicle and one of the emergency vehicle and a stationary vehicle associated with the emergency vehicle is monitored. A steering gear is actuated to laterally move the host vehicle out of the first lane into a pre-determined object-free space that is parallel to the host vehicle, when the distance between the host vehicle and one of the emergency vehicle and the stationary vehicle reaches a predetermined value. The longitudinal motion of the vehicle is also controlled by the vehicle power train and/or braking module to bring the vehicle to a calculate speed that is deemed safe before the lateral motion is initiated to deliver the host vehicle into the object-free space.

In another aspect of the invention, a system for autonomously assisting the operation of a host vehicle traveling on a first lane of a roadway includes at least one camera assembly for detecting the presence of an emergency vehicle along the roadway. A proximity sensor monitors the distance between the host vehicle and one of the emergency vehicle and an associated stationary vehicle. A controller connected to the at least one camera assembly and the proximity sensor actuates a steering gear to laterally move the host vehicle out of the first lane when the distance between the host vehicle and one of the emergency vehicle and the stationary vehicle reaches a predetermined value.

Other objects, advantages and a fuller understanding of the invention will be outlined in the following detailed description and the accompanying drawings.

### BRIEF DESCRIPTION OF THE DRAWINGS

FIG. 1 is a top view of a host vehicle having an assist system in accordance with an embodiment of the present invention.

FIG. 2 is a schematic illustration of the assist system of FIG. 1.

FIG. 3 is a schematic illustration of the host vehicle traveling in a first lane of a roadway and detecting an emergency vehicle in a first condition.

FIG. 4 is a schematic illustration of the host vehicle of FIG. 3 switching to a second lane of the roadway.

FIG. 5 is a schematic illustration of the host vehicle of FIG. 3 passing the emergency vehicle.

FIG. 6 is a schematic illustration of the host vehicle of FIG. 3 returning to the first lane.

FIG. 7 is a schematic illustration of the host vehicle traveling in a first lane of a roadway and detecting an emergency vehicle in a second condition traveling behind the host vehicle.

FIG. 8 is a schematic illustration of the host vehicle of FIG. 7 pulling over to the side of the roadway.

FIG. 9 is a schematic illustration of the host vehicle traveling in a first lane of a roadway and detecting an emergency vehicle in a third condition behind the host vehicle.

FIG. 10 is a schematic illustration of the host vehicle of FIG. 9 switching to the second lane of the roadway to allow the emergency vehicle to pass.

FIG. 11 is a schematic illustration of the emergency vehicle passing the host vehicle of FIG. 9.

### DETAILED DESCRIPTION

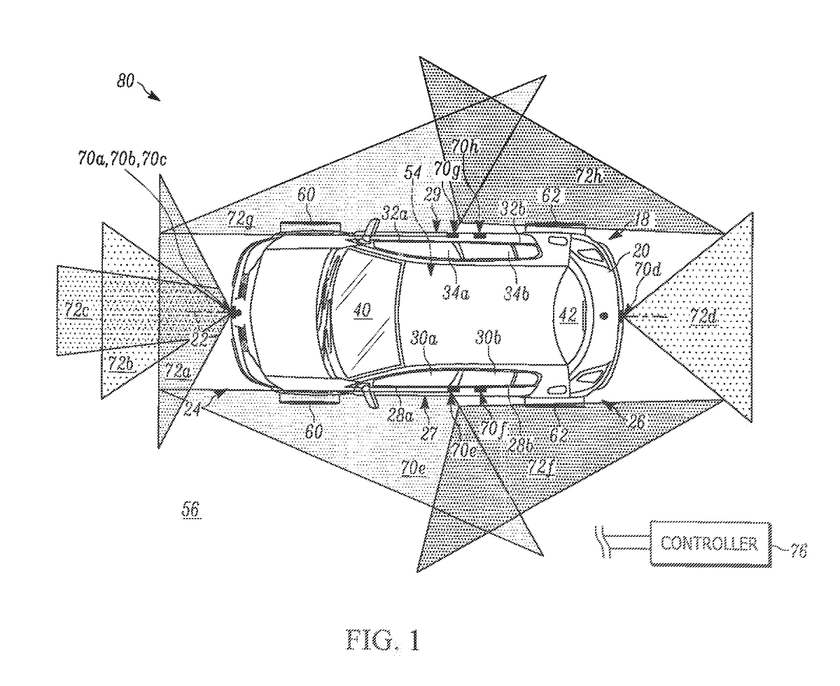

The present invention relates generally to vehicle systems and, more specifically, relates to a system for helping a vehicle respond to the presence of an emergency vehicle. FIG. 1 illustrates a host vehicle 20 having an assist system 80 in accordance with an embodiment of the present invention.

The host vehicle 20 extends along a centerline 22 from a front end 24 to a rear end 26. The host vehicle 20 includes a left side 27 and a right side 29 positioned on opposite sides of the centerline 22. The left side 27 includes a pair of doors 28a, 28b each having an associated window 30a, 30b. The right side 29 includes a pair of doors 32a, 32b each having an associated window 34a, 34b.

The front end 24 of the host vehicle 20 includes a front window or windshield 40 extending generally between the left and right sides 27, 29. The rear end 26 of the host vehicle 20 includes a rear window 42 extending generally between the left and right sides 27, 29. The windows 30a, 30b, 32a, 32b, 40, 42 and doors 28a, 28b, 32a, 32b collectively help define an interior 54 of the host vehicle 20. The exterior of the host vehicle 20 is indicated generally at 56.

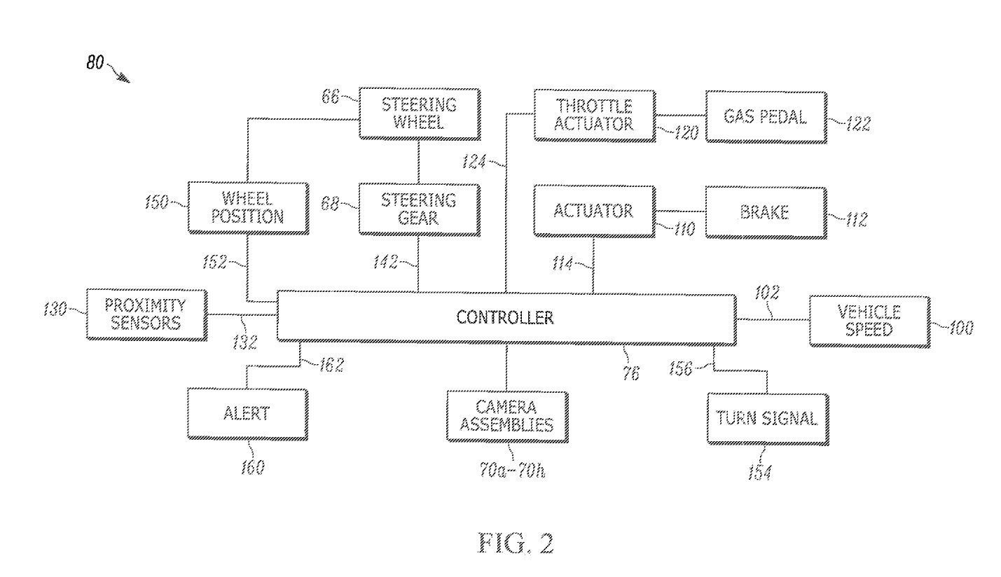

The host vehicle 20 includes a pair of front steerable wheels 60 and a pair of rear wheels 62. The front wheels 60 are mechanically linked to a steering actuator or gear 68 (see FIG. 2), which is mechanically linked to a steering wheel 66. Alternatively, the front wheels 62 and steering wheel 66 could be part of a steer-by-wire system (not shown). The rear wheels 62 could also be coupled to the steering wheel 66 by the same steering gear 68 or another steering gear (not shown).

In any case, rotation of the steering wheel 66 actuates the steering gear 68 to turn the wheels 60 relative to the centerline 22 in order to steer the host vehicle 20. To this end, the steering wheel 66 has a neutral position in which the wheels 60 point in directions that are parallel to the centerline 22 such that the host vehicle moves in a straight line. Counterclockwise rotation of the steering wheel 66 angles the wheels 60 leftward relative to the centerline 22 (as shown in FIG. 1), causing the host vehicle 20 to turn left. Clockwise rotation of the steering wheel 66 angles the wheels 60, 62 rightward relative to the centerline 22, causing the host vehicle 20 to turn right.

The assist system 80 includes a surround view system 18 for capturing images of the host vehicle exterior 56. The surround view system 18 includes camera assemblies 70a-70h provided around the periphery of the host vehicle 20. As shown, camera assemblies 70a-70c are secured to the front end 24 of the host vehicle 20 along or adjacent to the centerline 22. A camera assembly 70d is secured to the rear end 26 of the host vehicle 20 along or adjacent to the centerline 22. A pair of camera assemblies 70e-70f is secured to the left side 27. A pair of camera assemblies 70g-70h is secured to the right side 29. All the camera assemblies 70a-70h face outward away from the host vehicle 20. It will be appreciated that more or fewer camera assemblies can be provided. In any case, all of the camera assemblies 70a-70h are electrically or wirelessly connected to a controller 76 in the host vehicle 20.

Each camera assembly 70a-70h has an associated field of view 72a-72h covering a portion of the host vehicle exterior 56. Collectively, the fields of view 72a-72h encircle the entire vehicle 20 and overlap one another. The controller 76 continuously receives images taken by the camera assemblies 70a-70h within the respective fields of view 72a-72h. The controller 76 includes an image processing module (not shown) that receives and analyzes the data associated with the images from the camera assemblies 70a-70h. The controller 76 can, for example, stitch the images together to form a 360° surround view (not shown) of the host vehicle exterior 56. The images can also be relied on to identify objects around the host vehicle 20.

Referring to FIG. 2, the controller 76 is also electrically or wirelessly connected with various sensors and actuators in the host vehicle 20 for monitoring and controlling several functions of the host vehicle, namely, vehicle speed and steering. To this end, the controller 76 is electrically or wirelessly connected to a vehicle speed sensor 100. The speed sensor 100 monitors the host vehicle speed and generates an electrical signal 102 indicative thereof that is sent to the controller 76 at predetermined time intervals.

The controller 76 is also electrically or wirelessly connected to an actuator 110 associated with the vehicle brake 112 and a throttle actuator 120 associated with the gas pedal 122. The controller 76 can send a control signal 114 to the brake actuator 110 to decrease the host vehicle 20 speed. The controller 76 can send a control signal 124 to the throttle actuator 120 to increase the host vehicle 20 speed.

A wheel position sensor 150 monitors the rotational angle of the steering wheel 66 and generates an electrical signal 152 indicative of the steering angle. The signal 152 is sent to the controller 76 at predetermined time intervals. The controller 76 can send a control signal 142 to the steering gear 68 in response to the wheel position signal 152, thereby controlling rotation of the steering wheel 66. The steering gear 68 actuation also controls the steering angle of the front wheels 60 relative to the centerline 22 of the host vehicle 20.

At least one proximity sensor 130 is electrically or wirelessly connected to the controller 76 for acquiring data related to objects around the host vehicle exterior 56. The at least one proximity sensor 130 can include, for example, laser scanners, ultrasonic sensors, radar detectors, and LIDAR detectors, for determining and monitoring the distance between the host vehicle 20 and objects around the host vehicle exterior 56 detected by the camera assemblies 70a-70h.

Based on this construction, the controller 76 is capable of receiving continuous feedback regarding the driving conditions of the host vehicle, e.g., vehicle speed and steering angle, images around the host vehicle exterior 56, and the distance between the host vehicle and objects identified in the images. The controller 76, in response to these inputs, is capable of controlling vehicle operation in a manner that helps increase occupant safety. More specifically, the controller 76 is capable of autonomously controlling the host vehicle 20 position (lateral motion) and/or speed (longitudinal motion) in response to detecting the presence of an emergency vehicle.

A turn signal 154 constituting a lever or button is electrically or wirelessly connected to the controller 76 for notifying other vehicles when the host vehicle 20 intends to changes lanes 202, 204 or move onto/off the roadway 200. To this end, the controller 76 automatically sends a signal 156 to the turn signal 154 before and/or while the host vehicle 20 laterally moves along, onto or off the roadway 200. In response, the turn signal 154 will actuate lights (not shown) on the host vehicle 20 indicating the intended direction of lateral movement of the host vehicle.

An alert 160 is electrically or wirelessly connected to the controller 76 for providing feedback to the operator of the host vehicle 20 before and/or while autonomous operations are performed by the assist system 80. The alert 160 provides visual, audio or haptic feedback to the operator before and/or when the controller 76 sends a signal 162 thereto.

In one example, the assist system 80 helps the host vehicle 20 maintain a safe distance from an emergency vehicle stopped along the side of a roadway and any stationary vehicles associated therewith. “Emergency vehicle” as described herein includes public safety vehicles, traditional emergency vehicles, and road service vehicles. Example emergency vehicles can include ambulances, tow trucks, fire trucks, police vehicles, snow plows, etc.

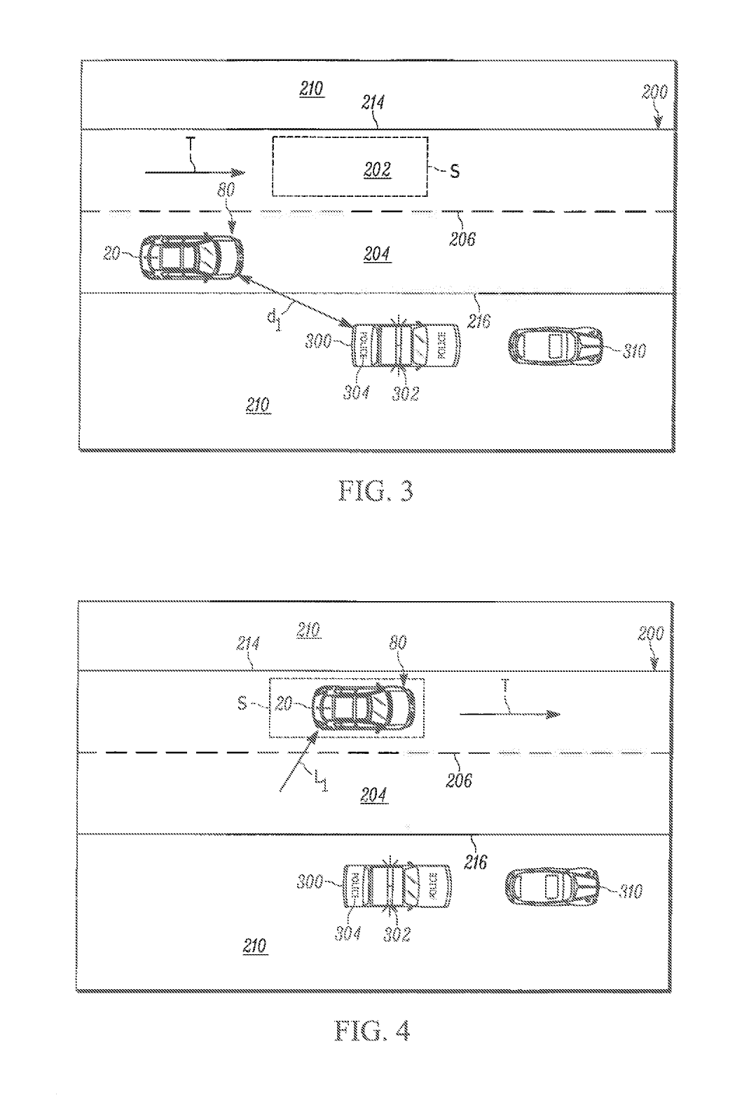

An example roadway 200 is shown in FIG. 3 and has a direction of vehicle travel illustrated by the arrow T. The roadway 200 includes a series of lanes 202, 204 separated by a dashed dividing line 206. Additional lanes and dividing lines are contemplated but not shown. The roadway 200 is defined from the surrounding off-road terrain 210 by a boundary line 214 on the left side (relative to the traveling direction T) and by a boundary line 216 on the right side.

In FIG. 3, the host vehicle 20 travels within the lane 204 in the direction T. The emergency vehicle 300 is shown pulled over to the right of the boundary line 216 in the off-road terrain 210. It will be appreciated that the emergency vehicle 300 could likewise be pulled over to the left of the boundary line 214 in the off-road terrain (not shown). In any case, the emergency vehicle 300 is stationary.

The emergency vehicle 300 can include one or more flashing, oscillating or rotating emergency lights 302 that, when activated, are visible to traffic approaching or driving in front of the emergency vehicle. The emergency vehicle 300 can also include indicia 304 on the top, sides, etc. indicative of the nature of the emergency vehicle, e.g., the words “Towing” or “Police”. Depending on the situation, the emergency vehicle 300 is parked along the roadway 200 adjacent to one or more stationary vehicles 310 and rending aid and/or assistance thereto. The vehicle 310 can be disabled, have a flat tire, have an occupant needing medical assistance, etc. As shown, a single stationary vehicle 310 is located in front of the emergency vehicle 300. The number and location of such stationary vehicles 310 could be different from that shown.

Occupants of the vehicles 300, 310 could be entering and exiting the respective vehicle or walking on/around the off-road terrain 210 adjacent to the boundary line 216. Consequently, it is desirable for traffic in the lane 204 to switch lanes when passing the vehicles 300, 310. In fact, certain states require vehicles driving in lanes adjacent to stopped emergency vehicles to either slow down or switch lanes while passing the vehicles to improve safety.

FIGS. 4-6 illustrate one example movement of the host vehicle 20 between lanes 202, 204 in response to detecting an emergency vehicle 300 along the roadway 200. In FIG. 4, the controller 76 determines when an emergency vehicle 300 is stopped along the roadway 300 based on images received from the camera assemblies 70a-70h. The camera assemblies 70a-70h can detect, for instance, the activated lights 302 and/or indicia 304 on the emergency vehicle 300 that distinguish it from other vehicles. The camera assemblies 70a-70h also detect the presence of any associated stationary vehicle(s) 310 behind or ahead of the emergency vehicle 300. The controller 76 relies on the proximity sensors 130 and/or camera assemblies 70a-70h to determine and monitor a distance d₁ between the host vehicle 20 and whichever vehicle 300 or 310 is closest to the host vehicle (the emergency vehicle 300 as shown in FIG. 4).

The controller 76 is programmed with a predetermined value for the distance d₁ that, when reached, determines when the host vehicle 20 should switch lanes. The assist system 80 simultaneously determines—via the camera assemblies 70a-70h and/or proximity sensors 130—whether other vehicles, objects, obstacles, etc. are present in the lane 202 before the host vehicle 20 switches lanes. If other vehicles prevent the host vehicle 20 from immediately moving laterally when desired, the controller 76 can send signals 114, 124 to the respective actuators 110, 120 to adjust the vehicle 20 speed until the lane change can be accomplished. The decision whether to adjust the vehicle 20 speed or change lanes 202, 204 is based on a series of algorithms and/or look-up tables that rely on the data acquired by the assist system 80.

To this end, the assist system 80 continuously scans the lane 202 and calculates an object-free space S into which the vehicle 20 can move without colliding with other vehicles and/or obstacles. The object-free space S is a 2-dimensional area projected onto the lane 202 whose size and shape is based on the speed and position of any surrounding vehicles or objects (not shown).

That said, once the distance d₁ reaches the predetermined value and the object-free space S established, the controller 76 takes active measures to move the host vehicle 20 leftward into the space within the lane 202 while passing the vehicles 300, 310. This occurs without driver intervention or assistance, i.e., the move is autonomously performed. More specifically, the controller 76 actuates the steering gear 68 to rotate the steering wheel 66 counterclockwise from the neutral position, thereby causing the host vehicle 20 to move laterally in the direction L₁ into the object-free space S in the lane 202.

While the lane change occurs, the camera assemblies 70a-70h capture images of the lane line 206 and the boundary line 214 that are sent to the controller 76. The controller 76 relies on the proximity sensors 130 to monitor the distance between the host vehicle 20 and each of the lines 206, 214. The wheel position sensor 150 continuously supplies electrical signals 152 to the controller 76. As a result, the controller 76 can analyze the images from the camera assemblies 70a-70h and the signals 132 from the proximity sensors 130 and actuate the steering gear 68 in a manner that transitions the host vehicle 20 into the lane 202 while avoiding crossing over the boundary line 214. The controller 76 ultimately returns the steering wheel 66 to the neutral position such that host vehicle 20 travels in a straight line in the lane 202 in the direction T. The controller 76 sends a signal 162 to the alert 160 to provide feedback to the operator before and/or while the host vehicle 20 is autonomously switched to the lane 202. At the same time, the controller 76 sends a signal 156 to the turn signal 154 to actuate lights indicative of moving laterally in the direction L₁.

Referring to FIG. 5, the host vehicle 20 safely passes both vehicles 300, 310 with the lane 204 providing a safe space between the moving host vehicle and the stationary vehicles 300, 310. The controller 76 relies on the camera assemblies 70a-70h and proximity sensors 130 to continuously monitor the positions of each vehicle 300, 310 relative to the host vehicle 20. The controller 76 then causes the host vehicle 20 to switch back to the lane 204 once the host vehicle is a predetermined minimum distance d₂ past whichever vehicle 300 or 310 is furthest down the roadway 200 in the direction of travel T and the object-free space S determined.

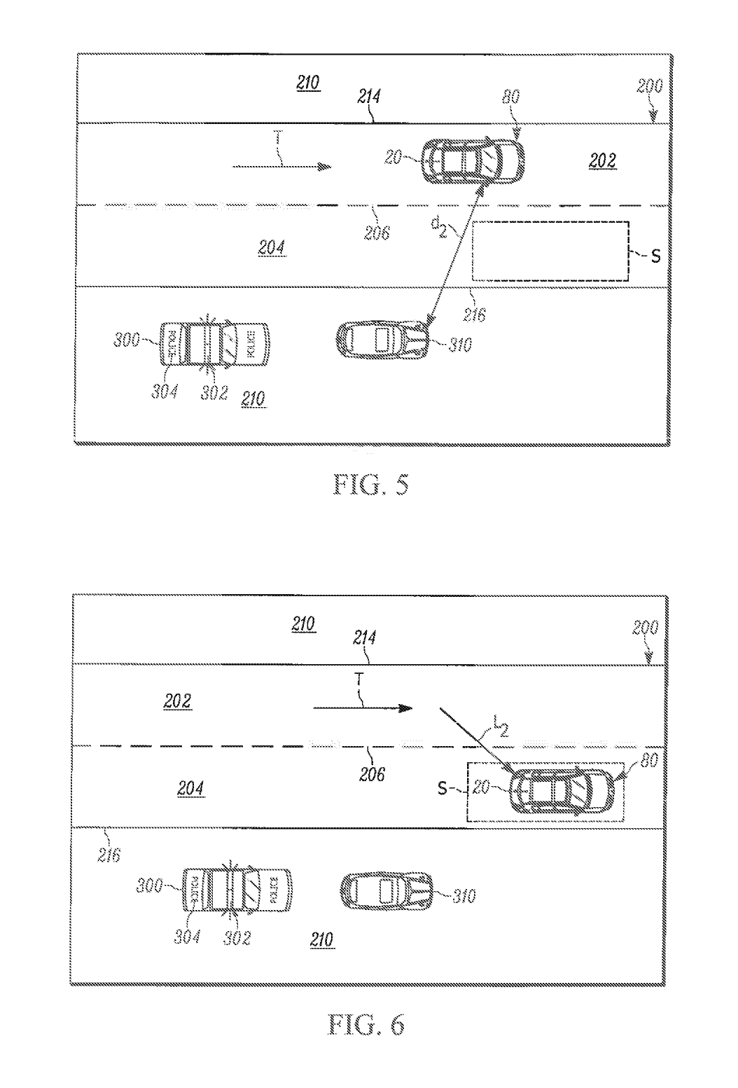

In FIG. 6, the controller 76 therefore determines when it is safe to move the host vehicle 20 back to the lane 204 and ahead of the vehicle 310 within the predefined, object-free space S. To this end, the host vehicle 20 is laterally moved in the direction L₂ into the lane 204 when the controller 76 determines that the host vehicle 20 reaches the minimum distance d₂ from the vehicle 310. To move the host vehicle 20 back to the lane 204, the controller 76 actuates the steering gear 68 to rotate the steering wheel 66 clockwise from the neutral position, thereby causing the host vehicle to move laterally in the direction L₂ into the object-free space S in the lane 204 ahead of the vehicle 310. The exact trajectory of the lateral movement L₂ and the host vehicle 20 speed are based on maintaining at least the minimum distance d₂ between the host vehicle and the vehicle 310.

While this occurs, the camera assemblies 70a-70h capture images of the lane line 206 and the boundary line 216 that are sent to the controller 76. The controller 76 relies on the proximity sensors 130 to monitor the distance between the host vehicle 20 and each of the lines 206, 216. The wheel position sensor 150 continuously supplies electrical signals 152 to the controller 76. As a result, the controller 76 can analyze the images from the camera assemblies 70a-70h and the signals 132 from the proximity sensors 130 and actuate the steering gear 68 in a manner that transitions the host vehicle 20 into the lane 204 while avoiding crossing over the boundary line 216. The controller 76 ultimately returns the steering wheel 66 to the neutral position such that the host vehicle 20 travels in a straight line in the lane 204 in the direction T. The controller 76 sends a signal 162 to the alert 160 to provide feedback to the operator before and/or while the host vehicle 20 is autonomously returned to the lane 204. At the same time, the controller 76 sends a signal 156 to the turn signal 154 to actuate lights indicative of moving laterally in the direction L₂.

If, upon first detecting the emergency vehicle 300, the controller 76 determines that vehicles are already present in the lane 202 such that no lane switching can occur, the controller sends a signal 114 to the brake actuator 110 sufficient to slow the host vehicle 20 to a predetermined value, e.g., 40 or 50 mph, that can correspond with state or local law. The controller 76 does not actuate the steering gear 68 and, thus, the host vehicle 20 continues moving in a straight line within the lane 204 in the direction T at the reduced speed.

Once the controller 76 determines that the host vehicle 20 reaches the minimum distance d₂ from the vehicle 310, the controller sends a signal 124 to the throttle actuator 120 to return the host vehicle to the posted legal speed or whatever value below the speed limit is needed due to congestion, weather, etc. The controller 76 sends a signal 162 to the alert 160 to provide feedback to the operator before and/or while the host vehicle 20 is autonomously slowed down or sped up.

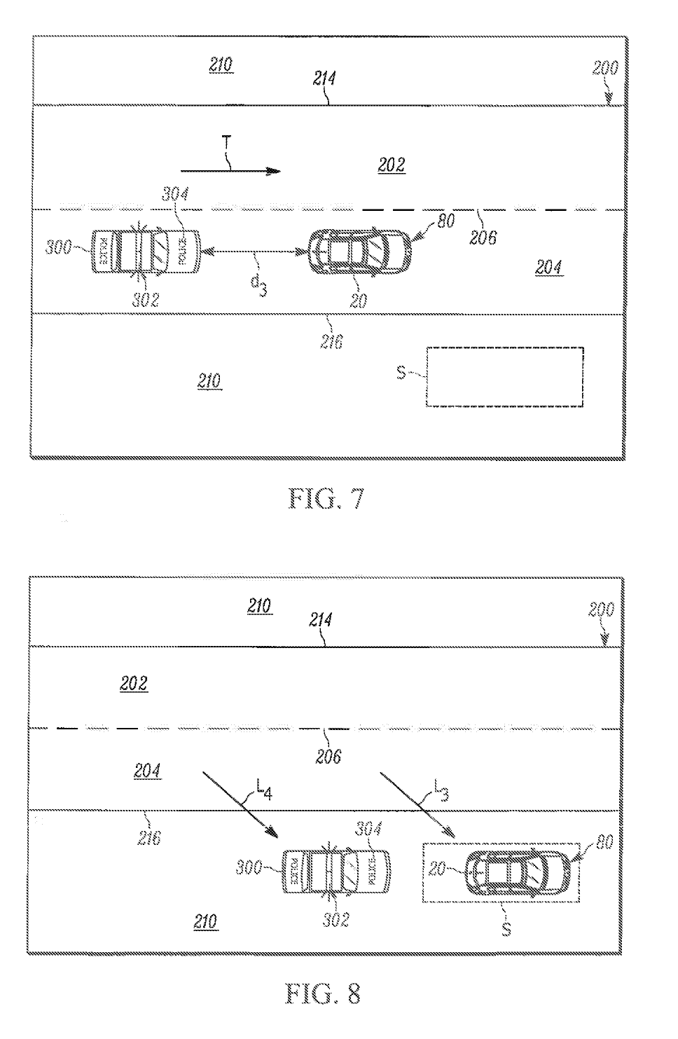

In another example shown in FIG. 7-8, the host vehicle 20 pulls over in response to determining that the emergency vehicle 300 is a police vehicle traveling along the roadway 200. More specifically, in FIG. 7, the host vehicle 20 is traveling in the lane 204 in the direction T. An emergency vehicle 300 approaches the host vehicle 20 from behind and within the lane 204. The camera assemblies 70a-70h detect the presence of the emergency vehicle 300 by detecting the activated lights 302 and/or the indicia 304. The controller 76 analyzes the images and determines that the activated lights 302 and/or indicia 304 are indicative of a police vehicle.

The controller 76 also monitors the distance d₃ between the host vehicle 20 and the police vehicle 300. If the distance d₃ closes to within a predetermined amount, the controller 76 is programmed to autonomously pull the host vehicle 20 over. In other words, the controller 76 assumes such a close distance d₃ indicates the police vehicle 300 wants to pull the host vehicle 20 over and responds accordingly. Furthermore, the camera assemblies 70a-70h could recognize the police vehicle 300 additionally flashing its headlights (not shown) to indicate a desire for the host vehicle 20 to pull over and respond accordingly.

To this end, the controller 76 actuates the steering gear 68 to rotate the steering wheel 66 clockwise from the neutral position, thereby causing the host vehicle 20 to move laterally in the direction L₃. The host vehicle 20 moves in the direction L₃ until the host vehicle 20 crosses the boundary line 216 and is positioned entirely on the off-road section 210 to the right of the boundary line within the predefined, object-free space S. The controller 76 sends a signal 162 to the alert 160 to provide feedback to the operator before and/or while the host vehicle 20 is autonomously pulled over the boundary line 216. At the same time, the controller 76 sends a signal 156 to the turn signal 154 to actuate lights indicative of moving laterally in the direction L₃.

At the same time, the controller 76 relies on the proximity sensors 130 to monitor the distance between the host vehicle 20 and the boundary line 216. The wheel position sensor 150 continuously supplies electrical signals 152 to the controller 76. As a result, the controller 76 can analyze the images from the camera assemblies 70a-70h and the signals 132 from the proximity sensors 130 and actuate the steering gear 68 in a manner that transitions the host vehicle 20 to the off-road section 210 right of the boundary line 216. The controller 76 sends a signal 114 to the brake actuator 110 prior to and/or following the host vehicle 20 crossing the boundary line 216 to apply the brake 112 and ultimately bring the host vehicle 20 to a stop on the off-road section 210. To this end, the controller 76 can rely on the images from the camera assemblies 70a-70h to determine when the off-road terrain 210 is present and utilize the brake 112 accordingly.

It will be appreciated that although FIGS. 7-8 illustrate the host vehicle 20 moving from the lane 204 to the off-road terrain 210 to the right of the boundary line 216 the assist system 80 could likewise be used to autonomously move the host vehicle laterally from the lane 202 to the off-road terrain 210 either on the left side of the roadway or the right side in accordance with the present invention. In either instance, the controller 76 will cooperate with the camera assemblies 70a-70h to ensure that no vehicles are present in the lane 202, 204 the host vehicle 20 intends to switch to before actually performing the lane switch.

Moreover, the controller 76 can be configured such that the driver cannot override the lateral movement L₃ by the host vehicle 20. In other words, the host vehicle 20 will automatically pull over to the side of the roadway 200 when a police vehicle 300 moves to within a distance implied to indicate the police want the host vehicle to pull over. That said, the police vehicle 300 moves laterally in the direction L₄, crosses the boundary line 216, and parks behind the host vehicle 20. The police officer can then proceed to normal police procedure for pulled over vehicles.

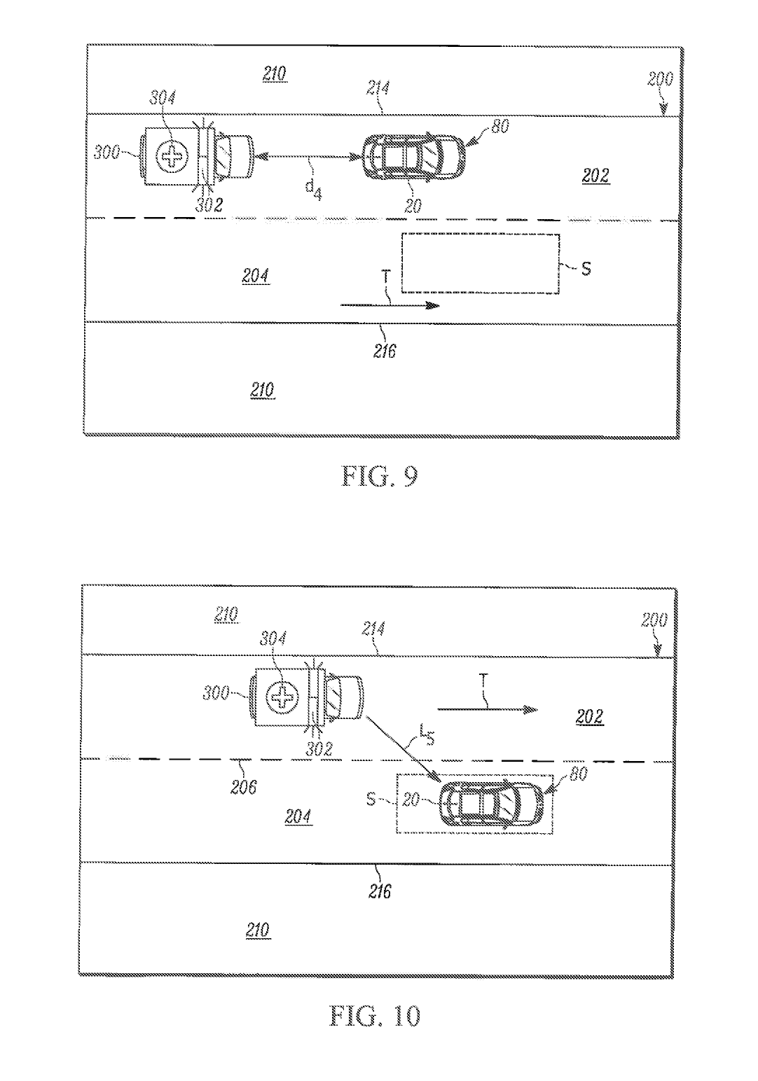

In another example shown in FIG. 9-11, the host vehicle 20 switches lanes in response to detecting an emergency vehicle 300 that is an ambulance traveling along the roadway 200. More specifically, in FIG. 9, the host vehicle 20 is traveling in the lane 202 in the direction T. An emergency vehicle 300 approaches the host vehicle 20 from behind and within the lane 202. The camera assemblies 70a-70h detect the presence of the emergency vehicle 300 as well as the activated lights 302 and/or indicia 304. The controller 76 analyzes the images and determines that the activated lights 302 and/or indicia 304 are indicative of an ambulance.

The controller 76 also monitors the distance d₄ between the host vehicle 20 and the ambulance 300. If the distance d₄ closes to within a predetermined amount, the controller 76 is programmed to autonomously laterally move the host vehicle out of the lane 202. In other words, the controller 76 assumes such a close distance d₄ indicates the ambulance 300 wants the host vehicle 20 out of its traveling path and responds accordingly.

To this end, the controller 76 actuates the steering gear 68 to rotate the steering wheel 66 clockwise from the neutral position, thereby causing the host vehicle 20 to move laterally in the direction L₅. The host vehicle 20 moves in the direction L₅ until the host vehicle 20 crosses the lane line 206 and is positioned entirely within the lane 204 within the predefined, object-free space S. The controller 76 sends a signal 162 to the alert 160 to provide feedback to the operator before and/or while the host vehicle 20 is autonomously moved over the lane line 206. At the same time, the controller 76 sends a signal 156 to the turn signal 154 to actuate lights indicative of moving laterally in the direction L₅.

During lateral movement in the direction L₅, the controller 76 relies on the proximity sensors 130 to monitor the distance between the host vehicle 20 and each of the lines 206, 216. The wheel position sensor 150 continuously supplies electrical signals 152 to the controller 76. As a result, the controller 76 can analyze the images from the camera assemblies 70a-70h and the signals 132 from the proximity sensors 130 and actuate the steering gear 68 in a manner that transitions the host vehicle 20 into the lane 204 while avoiding crossing over the boundary line 2168. The controller 76 ultimately returns the steering wheel 66 to the neutral position such that the host vehicle 20 travels in a straight line in the lane 204 in the direction T.

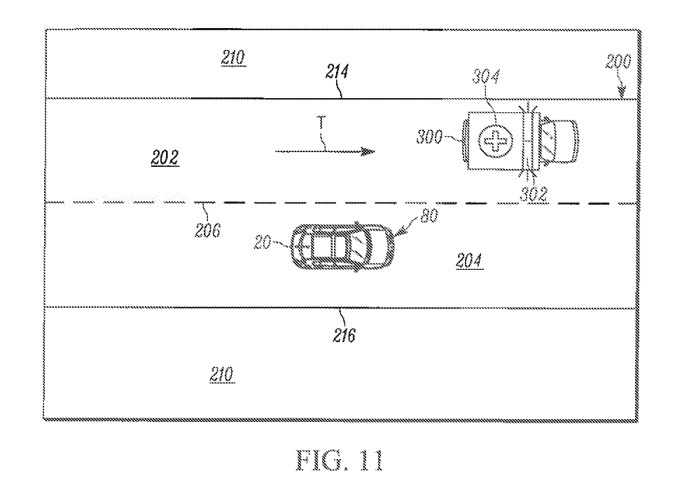

Once the host vehicle 20 switches to the lane 204 the ambulance 300 is free to safely pass the host vehicle 20 in the lane 202 as shown in FIG. 11. The controller 76 can then decide if the host vehicle remains in the lane 204 or returns to the lane 202 by actuating the steering gear 68 in the manner previously described.

The assist system of the present invention is advantageous in that the system can autonomously control the host vehicle on the roadway to respond to the presence and location of emergency vehicles. By relying on the controller and accompanying sensors—instead of solely the driver—to determine where and how close emergency vehicles are to the host vehicle, the present invention can more accurately navigate the host vehicle on the roadway to help increase safety and comply with traffic laws.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of autonomously assisting the operation of a host vehicle traveling on a first lane of a roadway, comprising:
detecting the presence of an emergency vehicle along the roadway;
monitoring the distance between the host vehicle and one of the emergency vehicle and a stationary vehicle associated with the emergency vehicle; and
actuating a steering gear to laterally move the host vehicle out of the first lane when the distance between the host vehicle and one of the emergency vehicle and the stationary vehicle reaches a predetermined value.

2. The method recited in claim 1, wherein actuating the steering gear comprises actuating the steering gear to laterally move the host vehicle from the first lane to a second lane when the at least one camera assembly determines that the emergency vehicle is in a stationary condition adjacent the roadway.

3. The method recited in claim 2 further comprising actuating the steering gear to laterally move the host vehicle from the second lane back to the first lane when the distance between the host vehicle and one of the emergency vehicle and the stationary vehicle reaches a second predetermined value.

4. The method recited in claim 1 further comprising detecting indicia on the emergency vehicle.

5. The method recited in claim 1 further comprising detecting activated emergency lights on the emergency vehicle.

6. The method recited in claim 1, wherein actuating the steering gear comprises actuating the steering gear to laterally move the host vehicle from the first lane to off-road terrain along the roadway when the at least one camera assembly determines that the emergency vehicle is a police vehicle traveling behind the host vehicle in the first lane.

7. The method recited in claim 6 further comprising actuating a brake to stop the host vehicle on the off-road terrain in response to the at least one camera assembly detecting the off-road terrain.

8. The method recited in claim 1 further comprising:
autonomously adjusting the host vehicle speed until an object-free space adjacent to the first lane is defined; and
actuating the steering gear to laterally move the host vehicle into the object-free space.

9. The method recited in claim 1, wherein actuating the steering gear comprises actuating the steering gear to laterally move the host vehicle from the first lane to a second lane when the at least one camera assembly determines that the emergency vehicle is an ambulance traveling behind the host vehicle in the first lane.

10. The method recited in claim 1 further actuating an alert connected to the controller for providing feedback to an operator of the host vehicle at least one of before and while the vehicle is laterally moved in an autonomous manner.

11. The method recited in claim 1 further comprising autonomously actuating a turn signal to indicate the direction of lateral movement of the host vehicle.

12. A system for autonomously assisting the operation of a host vehicle traveling on a first lane of a roadway, comprising:
at least one camera assembly for detecting the presence of an emergency vehicle along the roadway;
a proximity sensor for monitoring the distance between the host vehicle and one of the emergency vehicle and a stationary vehicle associated with the emergency vehicle; and
a controller connected to the at least one camera assembly and the proximity sensor for actuating a steering gear to laterally move the host vehicle out of the first lane when the distance between the host vehicle and one of the emergency vehicle and the stationary vehicle reaches a predetermined value.

13. The system recited in claim 12, wherein the controller actuates the steering gear to laterally move the host vehicle from the first lane to a second lane when the at least one camera assembly determines that the emergency vehicle is in a stationary condition along the roadway.

14. The system recited in claim 13, wherein the controller actuates the steering gear to laterally move the host vehicle from the second lane back to the first lane when the distance between the host vehicle and one of the emergency vehicle and the stationary vehicle reaches a second predetermined value.

15. The system recited in claim 12, wherein the at least one camera assembly is configured to detect indicia on the emergency vehicle.

16. The system recited in claim 12, wherein the at least one camera assembly is configured to detect activated emergency lights on the emergency vehicle.

17. The system recited in claim 12, wherein the controller actuates the steering gear to laterally move the host vehicle from the first lane to off-road terrain along the roadway when the at least one camera assembly determines that the emergency vehicle is a police vehicle positioned behind the host vehicle.

18. The system recited in claim 17, wherein the controller actuates a brake to stop the host vehicle on the off-road terrain in response to the at least one camera assembly detecting the off-road terrain.

19. The system recited in claim 12, wherein the controller actuates the steering gear to laterally move the host vehicle from the first lane to a second lane when the at least one camera assembly determines that the emergency vehicle is an ambulance positioned behind the host vehicle in the first lane.

20. The system recited in claim 12 further comprising an alert connected to the controller for providing feedback to an operator of the host vehicle at least one of before and while the vehicle is laterally moved in an autonomous manner.
